(19) United States
(12) Patent Application Publication
(10) Pub. No.: US 2009/0059162 A1
(43) Pub. Date: Mar. 5, 2009

(54) METHODS OF RELEASING AND HYDRATING OPHTHALMIC LENSES

(76) Inventor: Stephanie Allison, St. Augustine, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 12/048,320

(22) Filed: Mar. 14, 2008

Related U.S. Application Data
(60) Provisional application No. 60/909,004, filed on Mar. 30, 2007.

(51) Int. Cl. G02C 7/04

(52) U.S. Cl. 351/159; 264/1.36

(57) ABSTRACT

Methods of releasing and hydrating ophthalmic lenses are described herein.

### RELATED APPLICATION

This application is a non-provisional filing of a provisional application, U.S. Ser. No. 60/909,004, filed on Mar. 30, 2007.

This invention related to methods for manufacturing ophthalmic lenses.

### BACKGROUND

Contact lenses have been used commercially to improve vision since the 1950s. The first contact lenses were made of hard materials. Although these lenses are currently used, they are not suitable for all patients due to their poor initial comfort. Later developments in the field gave rise to soft contact lenses, based upon hydrogels, which are extremely popular today. Hydrogels are polymers that can be swollen with water (water equilibrated state) and will substantially retain the water during wear on an eye. These lenses have higher oxygen permeabilities and such are often more comfortable to wear than contact lenses made of hard materials. Even though there are methods of manufacturing these hydrogels are known, any method that speeds up the time to manufacture the lenses saves, time and the expense of producing goods, and is very valuable to contact lens manufacturers.

Many soft contact lenses are manufactured by a process where either partially polymerized or unpolymerized blends of components are placed between male and female mold parts and subsequently polymerized by either or both light and heat. Thereafter the polymerized lens is removed from the mold (“demolded”), hydrated with aqueous or organic solutions to swell the lens, and processed in subsequent steps (removal of unreacted components, inspection, packaging, and the like). In some cases either the male or the female mold part is mechanically removed and subsequent processing steps are conducted with the polymerized lens sitting in or adhered to the remaining mold part. Details these and other demolding process and subsequent steps may be found in the following publications U.S. Pat. Nos. 5,850,107; 5,080,839; 5,039,459; 4,889,664, and 4,495,313, all of the foregoing publications are hereby incorporated by reference in their entirety.

When the lenses are demolded the pliable lenses can be damaged by the mechanical force used to remove either or both the male or female halves of the lens mold. Others have attempted to solve this problem by a variety of methods. In one such attempt, the male mold half is heated prior to the demolding step and subsequently removed. See, U.S. Pat. No. 6,663,801, which is hereby incorporated by reference in its entirety. Even though this method is effective, it would be beneficial if there were other methods of removing the cured lens from the mold. Particularly it would be advantageous is the step of removing the cured lens from the mold and hydrating the lens were combined. This need is met by the following invention.

### DETAILED DESCRIPTION OF THE INVENTION

This invention includes a method of releasing an ophthalmic lens comprising, treating a molded cured disc with a processing solution and sonicating said cured disc and said solution for a sufficient period of time at an effective temperature.

As used herein “ophthalmic lens” refers to a device that resides in or on the eye. These devices can provide optical correction or may be cosmetic. The term ophthalmic lens includes but is not limited to soft contact lenses, intraocular lenses, overlay lenses, ocular inserts, and optical inserts. The preferred lenses of the invention are soft contact lenses are made from silicone elastomers or hydrogels, which include but are not limited to hydrogels, silicone hydrogels, and fluorohydrogels. Soft contact lens formulations are disclosed in U.S. Pat. No. 5,710,302, WO 9421698, EP 406161, JP 2000016905, U.S. Pat. No. 5,998,498, U.S. patent application Ser. No. 09/532,943, U.S. Pat. No. 6,087,415, U.S. Pat. No. 5,760,100, U.S. Pat. No. 5,776,999, U.S. Pat. No. 5,789,461, U.S. Pat. No. 5,849,811, U.S. Pat. No. 5,965,631, and silicone hydrogels as prepared in U.S. Pat. No. 5,998,498, U.S. patent application Ser. No. 09/532,943, a continuation-in-part of U.S. patent application Ser. No. 09/532,943, filed on Aug. 30, 2000, U.S. Pat. App. No. 60/318,536, entitled Biomedical Devices Containing Internal wetting Agents,” filed on Sep. 10, 2001 and its non-provisional counterpart of the same title, U.S. Ser. No. 10/236,538, filed on Sep. 6, 2002, U.S. Pat. No. 6,087,415, U.S. Pat. No. 5,760,100, U.S. Pat. No. 5,776,999, U.S. Pat. No. 5,789,461, U.S. Pat. No. 5,849,811, and U.S. Pat. No. 5,965,631. These patents as well as all other patents disclosed in this application are hereby incorporated by reference in their entirety. The particularly preferred lenses of the inventions made from etafilcon A, galifilcon A, senofilcon A, lenefilcon A, lotrfilcon A, lotrifilcon B, balifilcon A, polymacon, genfilcon A, lenefilcon A, bafilcon, acofilcon A acquafilcon A, alofilcon A alphafilcon A, amifilcon A, astifilcon A, atalafilcon A, bisfilcon A bufilcon A, crofilcon A, cyclofilcon A, darfilcon A deltafilcon A, deltafilcon B, dimefilcon A, drooxifilcon A, epsifilcon A, esterifilcon A, focofilcon A, galyfilcon A, govafilcon A, hefilcon A hefilcon B, hefilcon D, hilafilcon A, hilafilcon B, hixoifilcon A, hioxifilcon B, hioxifilcon C, hydrofilcon A, licryfilcon A, licryfilcon B, lidofilcon B, lidofilcon A, mafilcon A, mesifilcon A, methafilcon B, mipafilcon A, nelfilcon A, netrafilcon A, ocufilcon A, ocufilcon B, ocufilcon C, ocufilcon D, ocufilcon E, ofilcon A, omafilcon A, oxyfilcon A, pentafilcon A, perfilcon A, pevafilcon A, phemfilcon A, silafilcon A, siloxyfilcon A, tefilcon A, tetrafilcon A, trifilcon A, vifilcon A, or xylofilcon A. More particularly preferred lenses of the invention are made from etafilcon A, galifilcon A, senofilcon A, lenefilcon A, lotrfilcon A, lotrifilcon B, or balifilcon A, The most particularly preferred lenses are made from etafilcon A.

“Molded cured disc,” refers the combination of at least two of three components, a cured disc and either or both a male mold and a female mold. It is preferred that the molded cured disc is the combination of all three components a cured disc surrounded by the male and female mold member in which the disc was cured. The cured disc is the mixture of components that are used to make the hydrogel formulation and has been cured to a hard substance by any of the known curing methods, which include but are not limited to radiation, light, and heat. Due to the curing process, the front and back surfaces of the cured disc are adhered to its corresponding male and female mold halves, also known as the back and front curves, respectively. While the degree of adherence of the cured disc to the front and back curve molds varies with the formulation of the lens, adherence can be demonstrated by examining a cured disc and its corresponding molds after the cure process. If one lifts this unit along the circumferential edge of one of the mold pieces and the unit remains together, the cured disc is adhered to its mold. The term “releasing” refers to eliminating the adherence of the surfaces of the cured disc to the front and back curves of the molds.

The male and female molds may be made from a variety of components such as plastics, metals and glass. The preferred molds are plastics. Examples of such plastics include but are not limited to materials disclosed in U.S. patent application Ser. No. 10/639,823, filed on Aug. 13, 2003 entitled “Molds for Producing Contact Lenses,” which is incorporated by reference in its entirety. Other mold materials are polymers copolymers, homopolymers and block co-polymers of polystyrene, polypropylene, and polyethylene. Examples of plastic molds are disclosed in the following documents, which are hereby incorporated by reference in their entirety, U.S. Pat. Nos. 5,094,609; 4,565,348; and 4,640,489. The male and female mold need not be of the same material. For example a lens mold assembly having a female mold made of a polypropylene and a male mold made of an alicyclic co-polymer of norbonene may be used. Particularly suitable mold materials include but are not limited to polystyrene, an alicyclic co-polymer that contains two different alicyclic monomers and is sold by Zeon Chemicals L.P. under the tradename ZEONOR. There are several different grades of ZEONOR, having of glass transition temperatures form 105-160° C. The particularly preferred ZEONOR, is ZEONOR 1060R, which according the to the manufacturer, ZEON Chemicals L.P. has an melt flow rate (“MFR”) range of 11.0 grams/10 minutes to 18.0 grams/10 minutes (as tested JISK 6719 (230° C.)), a specific gravity (H₂O=1) of 1.01 and a glass transition temperature of 105° C. The particularly preferred mold material for both mold halves is polystyrene.

As used herein “processing solution” refers to liquids that are used to wash, swell, or hydrate the cured disc. Examples of processing solutions include but are not limited to water, deionized water, diluents such as D20, aqueous salt solutions, alcohols such as methanol, ethanol, isopropanol, and the like, organic solvents, such as methylene chloride, hexane and the like. Processing aids including surfactants such as Tween, PEG, PVP, methyl cellulose, antibacterial agents and the like may be added to the processing solution. The preferred processing solutions are deionized water, isopropanol, and hexane. The most preferred processing solutions are water or deionzed water.

As used herein the term “treating” refers to any method of combining the molded cured disc with the processing solution. It is preferred that the molded cured disc be submerged in the processing solution.

As used herein the term “sonicating” refers to subjecting the molded cured disc and processing solution to multifrequency ultrasonic waves or ultrasonic waves. Multifrequency ultrasonic waves differ from ultrasonic waves. Typically these waves are generated by a device that has a frequency of 27.5-29.5 and a sweeping range of 0.2-0.5 kHz. Multifrequency ultrasonic waves are preferred and the preferred device for generation such sonic waves is Mastersonic MSG.X00 Ultrasonic Generator.

The phrase “sufficient period of time” refers to the time it takes to release the cured disc from the mold. It is preferred that the molded cured disc is sonicated for less than 20 about minutes, preferably less than 15 about minutes, more preferably less than 10 about minutes. The phrase effective temperature refers to the temperature at which the sonicating step is conducted. Preferably the effective temperature is less than about 50° C., more preferably less than about 30° C., most preferably ambient temperature.

Further, invention includes a method of releasing and hydrating an ophthalmic lens comprising, treating a molded cured disc with a processing solution and sonicating said cured disc and said solution for a sufficient period of time at an effective temperature. The terms “ophthalmic lens”, “releasing”, “treating”, “molded cured disc”, “effective temperature,” “processing solution”, and “sonicating” all have their aforementioned meanings and preferred ranges. The term “sufficient period of time” has the aforementioned meanings, but a different preferred range. The effective temperature and time for releasing and hydrating is typically longer than the time for releasing, preferably about 4 minutes longer. As used herein the term “hydrating” refers to swelling the cured disc with solution to its water equilibrated state form a hydrogel.

Still further the invention includes an ophthalmic lens prepared by a method comprising, treating a molded cured disc with a processing solution and sonicating said cured disc and said solution for a sufficient period of time at an effective temperature. The terms “ophthalmic lens”, “treating”, “molded cured disc”, “effective temperature,” “processing solution”, and “sufficient period of time,” “sonicating” all have their aforementioned meanings and preferred ranges.

The methods of this invention have many advantages. Most ophthalmic lenses are made in a manufacturing environment where speed from processing station to processing station is important. Many lenses are made using the separate steps of curing the lens between mold halves, mechanically removing either the front or back curve mold half and washing the lens adhered to the mold half with a solution to remove the lens from the remaining mold half and subsequently hydrating the lens to for a hydrogel. Releasing the cured lenses from a mold half (or two corresponding mold halves) in less time will save time and expenses. Combining the releasing and hydrating steps into one steps, saves even more time and expenses

A further advantage of the invention is that the defects associated with mechanically removing one or both mold halves is reduced or eliminated by the methods of this invention. The defects that are associated with the releasing and hydration process are chips, tears, and stress marks in the lenses. When the methods of the invention are used, the defect rate or the rate of chips and tear in finished lenses is reduced and the defect rate of stress marks is eliminated.

In order to illustrate the invention the following examples are included. These examples do not limit the invention. They are meant only to suggest a method of practicing the invention. Those knowledgeable in the production of lenses as well as other specialties may find other methods of practicing the invention. However, those methods are deemed to be within the scope of this invention.

### EXAMPLES

### Example 1

### Comparative Defect Rates

The uncured monomer used to prepare etafilcon A was placed between a male and a female mold halves made of polystyrene and cured at about 60-65° C. for 215-3600 seconds. The concave surface of the male molding member was heated with a silicon infra-red heater and demolded as described in U.S. Pat. No. 6,663,801. The dry lenses adhered to the female mold were washed with deionized water until they were hydrated, subsequently removed from the front curve by mechanical means, extracted with deionized water and then transferred to a package. The number of tears and chips were measured by automatic lens inspection and physical inspection. Under these conditions the average number of tears and chips in the finished lenses was 8.03%.

The uncured monomer used to prepare etafilcon A was placed between a male and a female mold halves made of polystyrene and cured as above. The cured lens adhered between a front and back curve was placed in hot tap water and sonicated with for a Mastersonic MSG.X00 Ultrasonic Generator using an ⅛ plastic wedge about 2.5 minutes. The lenses released from the molds and were extracted with water. The lenses were transferred to vials filled with packaging solution and the edge defects were measured by visual inspection and other physical methods. The average number of defects was 0.68% using this method.

### Example 2

### Comparison of Release Times Using Different Types of Sonication

The uncured monomer used to prepare etafilcon A was placed between a male and a female mold halves made of polystyrene and cured using. The cured lens adhered between a front and back curve was placed in deionized water and sonicated with either normal sonication Branson Sonicator or with multifrequency sonication using the Mastersonic MSG.X00 Ultrasonic Generator. at ambient temperature. The lenses were monitored at one minute intervals to determine when they released from the plastic molds. The release lenses were placed in a vial filled with packaging solution (buffered saline solution) and visually examined for defects. The time that it took for the lenses to release from the molds is noted for each device in Table 1. These results demonstrate that the release time for lenses treated with multifrequency sonication is much faster than for lenses treated with normal sonication.

TABLE 1

| Normal Sonication | | Multifrequency Sonication | |
|---|---|---|---|
| | Release Time In | | Release Time In |
| Lens | Minutes | Lens | Minutes |
| 1 | 22.5 | 1 | 3 |
| 2 | 5 | 2 | 1 |
| 3 | 14.5 | 3 | 3 |
| 4 | 25 | 4 | 4 |
| 5 | 27.5 | 5 | 2 |
| 6 | 31 | 6 | 2 |
| 7 | 26 | 7 | 7 |
| 8 | 24.5 | 8 | 10.5 |
| 9 | 2 | 9 | 5 |
| 10 | 2 | 10 | 11.5 |
| 11 | 26.5 | 11 | 2 |
| 12 | 3.5 | 12 | 4 |

What is claimed is:

1. A method of releasing an ophthalmic lens comprising, treating a molded cured disc with a processing solution and sonicating said cured disc and said solution for a sufficient period of time at an effective temperature.

2. The method of claim 1 wherein treating comprises immersing the molded cured disc and the processing solution is water.

3. The method of claim 1 wherein the sonicating comprises multifrequency ultrasonic waves.

4. The method of claim 1 wherein the sufficient period of time is less than about 20 minutes.

5. A method of releasing and hydrating an ophthalmic lens comprising, treating a molded cured disc with a processing solution and sonicating said cured disc and said solution for a sufficient period of time at an effective temperature.

6. The method of claim 5 wherein treating comprises immersing the molded cured disc and the processing solution is water.

7. The method of claim 5 wherein the sonicating comprises multifrequency ultrasonic waves.

8. The method of claim 5 wherein the sufficient period of time is less than about 24 minutes.

9. An ophthalmic lens prepared by a method comprising, treating a molded cured disc with a processing solution and sonicating said cured disc and said solution for a sufficient period of time at an effective temperature.

10. The method of claim 9 wherein the ophthalmic lens is selected from the group consisting of etafilcon A, galifilcon A, senofilcon A, lenefilcon A, lotrfilcon A, lotrifilcon B, balifilcon A, polymacon, genfilcon A, lenefilcon A, bafilcon, acofilcon A acquafilcon A, alofilcon A alphafilcon A, amifilcon A, astifilcon A, atalafilcon A, bisfilcon A bufilcon A, crofilcon A, cyclofilcon A, darfilcon A deltafilcon A, deltafilcon B, dimefilcon A, drooxifilcon A, epsifilcon A, esterifilcon A, focofilcon A, galyfilcon A, govafilcon A, hefilcon A hefilcon B, hefilcon D, hilafilcon A, hilafilcon B, hixoifilcon A, hioxifilcon B, hioxifilcon C, hydrofilcon A, licryfilcon A, licryfilcon B, lidofilcon B, lidofilcon A, mafilcon A, mesifilcon A, methafilcon B, mipafilcon A, nelfilcon A, netrafilcon A, ocufilcon A, ocufilcon B, ocufilcon C, ocufilcon D, ocufilcon E, ofilcon A, omafilcon A, oxyfilcon A, pentafilcon A, perfilcon A, pevafilcon A, phemfilcon A, silafilcon A, siloxyfilcon A, tefilcon A, tetrafilcon A, trifilcon A, vifilcon A, and xylofilcon A.

11. The method of claim 9 wherein the ophthalmic lens is selected from the group consisting of etafilcon A, galifilcon A, senofilcon A, lenefilcon A, lotrfilcon A, lotrifilcon B, and balifilcon A,
